(19) United States
(12) Patent Application Publication
(10) Pub. No.: US 2022/0379594 A1
(43) Pub. Date: Dec. 1, 2022

(54) SYSTEMS AND METHODS FOR GRADIENT SEAL FLEXIBLE FILMS

(71) Applicant: TRANSCONTINENTAL HOLDING CORP., Chicago, IL (US)

(72) Inventors: Casey BUCKNER, Chicago, IL (US); Carl BUNDY, Chicago, IL (US)

(73) Assignee: TRANSCONTINENTAL HOLDING CORP., Chicago, IL (US)

(21) Appl. No.: 17/884,409

(22) Filed: Aug. 9, 2022

Related U.S. Application Data
(60) Provisional application No. 62/231,167, filed on Jun. 26, 2015.

(51) Int. Cl. B32B 37/15; B32B 7/08; B32B 7/022; B32B 27/08

(52) U.S. Cl. CPC B32B 37/153; B32B 7/08; B32B 7/022; B32B 27/08; B32B 2250/02; B32B 2250/03; B32B 2250/05; B32B 2250/24; B32B 2250/44; B32B 2307/7244; B32B 2307/7246; B32B 2307/50; B32B 2553/00

(57) ABSTRACT

A film includes an outer layer and a sealant layer attached to the outer layer. The sealant layer includes a first layer having a first viscosity and a second layer having a second viscosity. The first layer is attached to the outer layer and the second layer is attached to the first layer. The first viscosity is greater than the second viscosity.

### TECHNICAL FIELD

The present disclosure relates generally to flexible packaging films, and more particularly relates to gradient seal flexible films, and related methods for making gradient seal flexible packaging films.

### BACKGROUND

Flexible packaging films have been used to create barriers that protect perishable goods (e.g., food) during transportation and storage of the perishable goods such as between a producer to a consumer. For example, films may include polymeric materials to prevent the passage of molecules including, for example, gases and water vapor, to protect the perishable goods from the deleterious effects of such gases and water vapors. The films are typically coextruded by feeding layers of polymeric materials into a feed block where they are arranged into a layered configuration prior to extrusion through a die. The films may include a sealant layer configured to seal the film to another material. However, conventionally extruded sealant layers for films are often required to perform in high intensity environments. Specifically, the sealant layer may be required to seal through contamination, pleats (folds made in the seals during the end seal process), fin seals, end seal triple points, and be receptive and seal through a compatible zipper. Typically, sealants have been extruded using very heavy coatings of high flow materials to overcome these issues. However, extruding heavy coatings of high flow materials may result in the sealant layer being squeezed out and overflowing against an outer ply, and/or onto processing or storage equipment.

For the foregoing reasons, there is a need to provide improved film structures with a sealant layer that does not squeeze out or overflow the outer ply.

### SUMMARY

One aspect of the present disclosure relates to a film including an outer layer and a sealant layer attached to the outer layer. The sealant layer includes a first layer having a first viscosity and a second layer having a second viscosity. The first layer is attached to the outer layer and the second layer is attached to the first layer. The first viscosity is greater than the second viscosity.

Another aspect of the present disclosure relates to a film including an outer layer, at least one intermediate layer attached to the outer layer, and a sealant layer attached to the at least one intermediate layer. The sealant layer includes a first layer attached to the at least one intermediate layer and a second layer attached to the first layer. The first layer has a first viscosity and the second layer has a second viscosity. The first viscosity is greater than the second viscosity.

The present disclosure also is directed to a method of manufacturing a flexible packaging film with an extrusion system. The extrusion system includes a first extruder, a second extruder, a feedblock, and a die. The method includes extruding a first material having a first viscosity using the first extruder to generate a first melt stream. The method also includes feeding the first melt stream to the feedblock. The method further includes extruding a second material having a second viscosity using the second extruder to generate a second melt stream. The first viscosity is greater than the second viscosity. The method also includes feeding the second melt stream to the feedblock. The method further includes combining the first melt stream with the second melt stream to form a combined melt stream using the feedblock. The method also includes feeding the combined melt stream through a die to form a flat sheet. The method may further include laminating at least one outer layer to the flat sheet.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a block flow diagram of an example extrusion system in accordance with the present disclosure.

FIG. 2 is a schematic cut-away/cross-sectional view of a film manufactured using the extrusion system illustrated in FIG. 1 in accordance with the present disclosure.

FIG. 3 is a schematic cut-away/cross-sectional view of a film manufactured using the extrusion system illustrated in FIG. 1 in accordance with the present disclosure.

FIG. 4 is a schematic cut-away/cross-sectional view of a sealant layer of the films illustrated in FIGS. 2 and 3 in accordance with the present disclosure.

FIG. 5 is a flow diagram illustrating an example method of manufacturing the films illustrated in FIGS. 2-4 with the extrusion system illustrated in FIG. 1 in accordance with the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The films described herein include a sealant layer having a plurality of layers with physical properties that reduce squeeze out and overflow of the sealant layer on an outer layer. Specifically, the layers include a first layer, a second layer, and a third layer that are arranged in descending order of viscosity. More specifically, the first layer has a first viscosity, the second layer has a second viscosity, and the third layer has a third viscosity. The first viscosity is greater than the second and third viscosities, and the second viscosity is greater than the third viscosity. The first layer has the highest viscosity and the highest resistance to flow and forms the base layer of the sealant layer because it is capable of supporting the second and third layers without overflowing the outer layer. The second layer has a lower viscosity than the first layer but a higher viscosity than the third layer. As such, the second layer resists flow more than the third layer and less than the first layer. Thus, the second layer is capable of supporting the third layer without overflowing the outer layer and is capable of flowing over the entire outer layer to initiate a seal when heated. The third layer has the lowest viscosity and the lowest resistance to flow. Thus, when heated, the third layer will be capable of flowing at an increased rate to fill any void spaces caused by zippers, pleats, or triple points to form a complete seal. The increased resistance to flow of the base layers (the first layer and the second layer) reduces overflow or squeeze out of the sealant layer over the outer layer while the decreased resistance to flow of the upper materials (the second layer and the third layer) increases the flow of the sealant layer when heated to fill any void spaces caused by zippers, pleats, or triple points to form a complete seal. Thus, the arrangement of the layers of the sealant layer reduces squeeze out and overflow of the sealant layer on the outer layer.

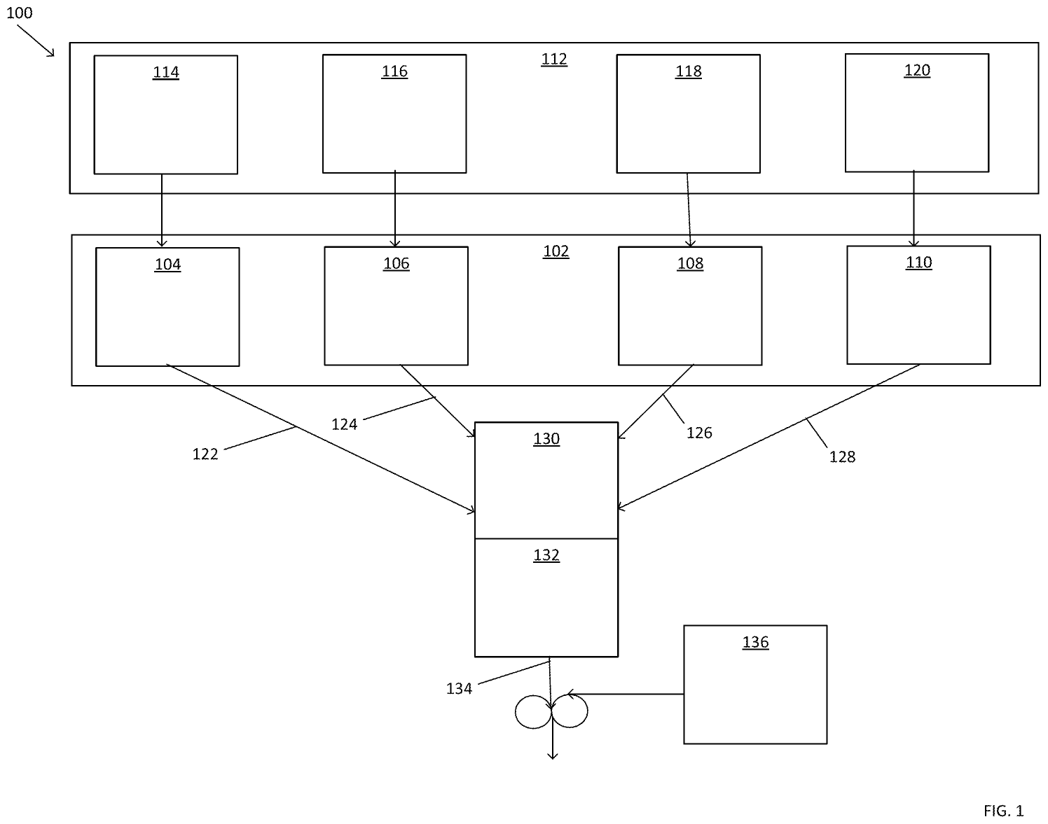

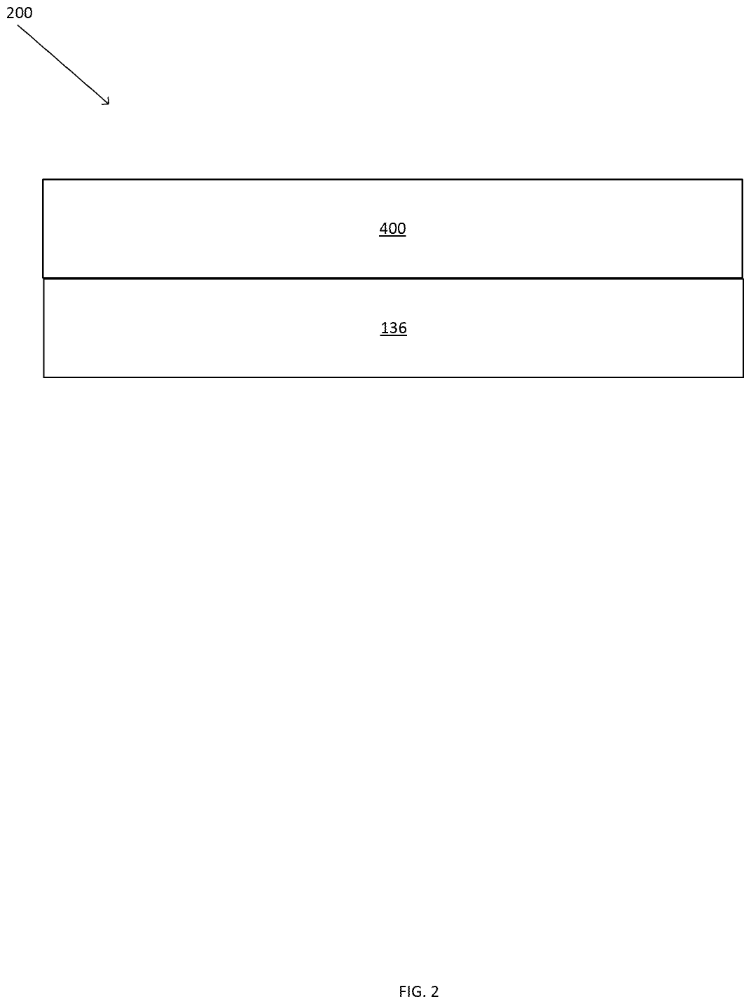

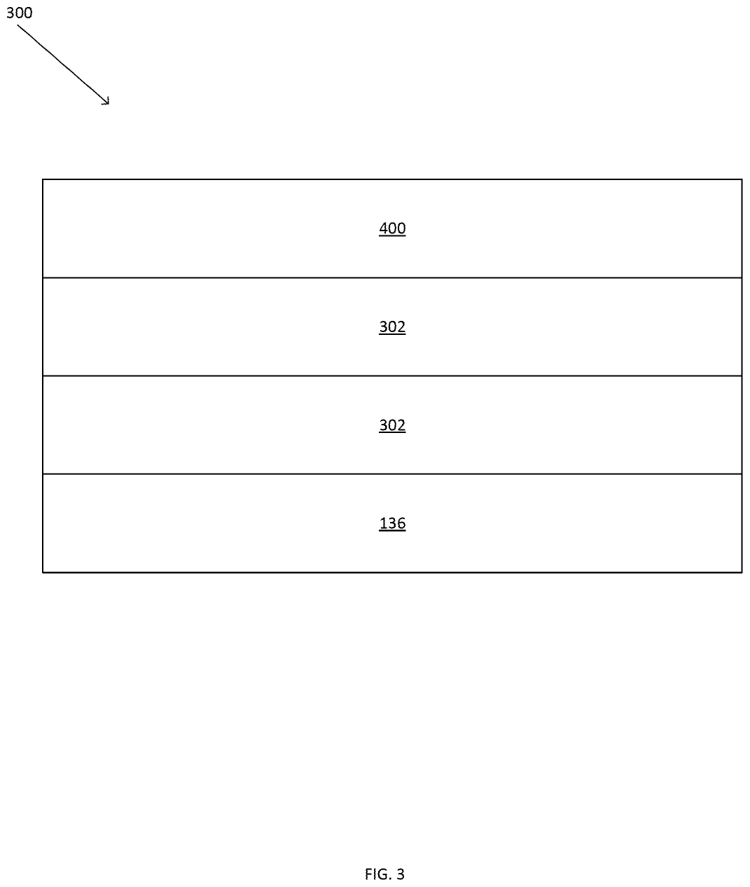

Referring now to the drawings wherein like numerals refer to like parts, FIG. 1 illustrates an extrusion system 100 for manufacturing a film 200 and 300 (shown in FIGS. 2 and 3). The extrusion system 100 may include a plurality of extruders 102 that may melt and extrude a material into a melt stream. In the illustrated embodiment, the extrusion system 100 includes at least three extruders 104, 106, and 108. More specifically, in the illustrated embodiment, the extrusion system 100 includes four extruders 104, 106, 108, and 110. In the illustrated embodiment, the extrusion system 100 includes a first extruder 104, a second extruder 106, a third extruder 108, and a fourth extruder 110. As described herein, the first, second, and third extruders 104-108 are configured to extrude a sealant layer 400 (shown in FIGS. 2-4) of the films 200 and 300, and the fourth extruder 110 is configured to extrude at least one intermediate layer 302 (shown in FIG. 3) of the film 300. Additionally, the films 200 and 300 may have any number of layers that enable the films 200 and 300 to operate as described herein and the extrusion system 100 may have any number of extruders 102 that enable the extrusion system 100 to manufacture the films 200 and 300 described herein.

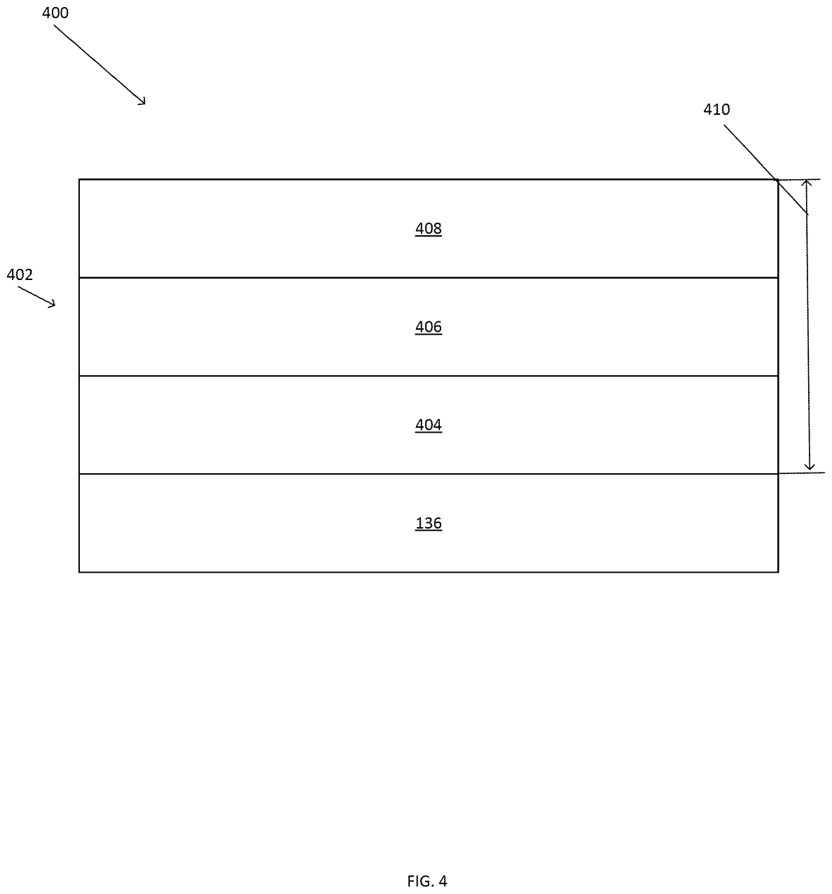

As shown in FIG. 1, the extruders 102 are each fed one of a plurality of materials 112. In the illustrated embodiment, the materials 112 include a first material 114, a second material 116, a third material 118, and a fourth material 120. As described above, the films 200 and 300 may have any number of layers that enable the films 200 and 300 to operate as described herein and the extruders 102 may be fed any number of materials that enable the extrusion system 100 to manufacture the films 200 and 300 described herein. In the illustrated embodiment, the first material 114 will form a first layer 402 (shown in FIG. 4) of the sealant layer 400, the second material 116 will form a second layer 404 (shown in FIG. 4) of the sealant layer 400, the third material 118 will form a third layer 406 (shown in FIG. 4) of the sealant layer 400, and the fourth material 120 will form at least one intermediate layer 302 of the films 200 and 300.

The extruders 102 each generate a melt stream 122, 124, 126, and 128 from the materials 112. The extruders 102 are each configured to melt the materials 112 and extrude the materials 112 into the melt streams 122-128. Specifically, in the illustrated embodiment, the first extruder 104 melts and extrudes the first material 114 to generate a first melt stream 122, the second extruder 106 melts and extrudes the second material 116 to generate a second melt stream 124, the third extruder 108 melts and extrudes the third material 118 to generate a third melt stream 126, and the fourth extruder 110 melts and extrudes the fourth material 120 to generate a fourth melt stream 128. As described above, the films 200 and 300 may have any number of layers that enable the films 200 and 300 to operate as described herein and the extruders 102 may generate any number of melt streams that enable the extrusion system 100 to manufacture the films 200 and 300 described herein.

In the illustrated embodiment, the extrusion system 100 further includes at least one feedblock 130 configured to combine the melt stream 122, 124, 126, and 128 in a way that results in a uniform layer distribution of the films 200 and 300. The feedblock 130 may include any feedblock technology that enables the extrusion system 100 to manufacture the films 200 and 300 described herein, including, but not limited to, vanes, laminar plates, plugs, pins, and other devices that enable the extrusion system 100 to manufacture the films 200 and 300 described herein. The melt streams 122, 124, 126, and 128 are combined by the feedblock 130 and transferred for further processing.

In the illustrated embodiment, the extrusion system 100 also includes a die 132 that receives the combined melt streams 122, 124, 126, and 128 to thin and spread the melt streams 122, 124, 126, and 128 into a flat sheet 134. After the sheet 134 is produced, it may be laminated with one or more outer layers 136 such as various substrates detailed below with reference to FIG. 2. During operations, the materials 112 are fed to the extruders 102 and the extruders 102 extrude the materials 112 into the melt streams 122, 124, 126, and 128. The melt streams 122, 124, 126, and 128 are then fed to the feedblock 130 and the feedblock 130 arranges the melt stream 122, 124, 126, and 128 into the uniform layer distribution of the films 200 and 300. The die 132 receives the combined melt streams 122, 124, 126, and 128 from the feedblock 130 and the die 132 thins and spreads the combined melt streams 122, 124, 126, and 128 into the flat sheet 134. The flat sheet 134 may then be laminated with one or more outer layers 136.

FIG. 2 illustrates the improved film 200 that may be produced by the extrusion system 100 described above with reference to FIG. 1. As shown in FIG. 2, the film 200 includes the outer layer 136 and the sealant layer 400 laminated to the outer layer 136. The sealant layer 400 is coextruded as described herein and may act as a sealant when heated. The outer layer 136 may include any substrate necessary to modify or tune the physical properties of the film 200. For example, the outer layer 136 may include any material that may add strength, stiffness, heat resistance, abuse resistance, durability and/or printability to the film 200. Further, the outer layer 136 may act to prevent the migration of certain types of molecules, such as, for example, moisture, from penetrating into the sealant layer 400 of the film 200. Further, the outer layer 136 may add flex crack resistance to the film 200. In addition, the outer layer 136 may be composed of a material that may act as a sealant when heated. However, it should be noted that the outer layer 136 may be composed of any material that enables the film 200 to operate as described herein.

Alternatively, the sealant layer 400 may be coextruded with one or more intermediate layers 302 as shown with reference to FIG. 3, rather than just the outer layer 136. Referring now to FIG. 3, the film 300 includes the outer layer 136, the sealant layer 400, and the one or more intermediate layers 302 coextruded with the sealant layer 400 and laminated to the outer layer 136. The sealant layer 400 is coextruded as described herein and may act as a sealant when heated. The outer layer 136 may include any substrate necessary to modify or tune the physical properties of the film 300. For example, the outer layer 136 may include any material that may add strength, stiffness, heat resistance, durability and/or printability to the film 300. Further, the outer layer 136 may act to prevent the migration of certain types of molecules, such as, for example, moisture, from penetrating into the sealant layer 400 of the film 300. Further, the outer layer 136 may add flex crack resistance to the film 300. In addition, the outer layer 136 may be composed of a material that may act as a sealant when heated. However, it should be noted that the outer layer 136 may be composed of any material that enables the film 300 to operate as described herein.

The one or more intermediate layers 302 may include an adhesive layer, a barrier layer, and/or any other type of layer that enables the film 300 to operate as described herein. In some embodiments, one or more intermediate layers 302 may include a barrier layer (not shown) that may be completely encapsulated by an adhesive layer (not shown). The barrier layer may be composed of any thermoplastic polymeric material that may prevent the migration of molecules such as, for example, oxygen and water vapor, thereby protecting sensitive materials contained within packages made from the film 300. For example, the film 300 may be utilized as a bag that may be sealed on all sides and may completely surround an article such as an article of food contained therein. The barrier layer may preferably be made from a material having superior barrier properties such as, for example, polymers and/or copolymers of Ethylene vinyl alcohol (EVOH) and EVOH blends of nylon or polyethylene. Moreover, other materials may include polyamide polymers, copolymers and blends thereof; polyvinylidene chloride and polyvinylidene chloride/methyl acrylate copolymer; acrylonitrile polymers and copolymers; and polyethylene copolymers and/or blends. The adhesive layer may preferably be made from resins of polyethylene; polyamide polymers, copolymers and blends thereof; acrylonitrile polymers and copolymers; and polyethylene copolymers and/or blends.

The barrier layer may be protected by the adhesive layer that may encapsulate the barrier layer via the extrusion system 100 described in FIG. 1. The adhesive layers may be coextruded to encapsulate the barrier layer to create an encapsulated extrudate (not shown) composed of the barrier layer completely surrounded by the adhesive layer. The encapsulated extrudate may then be coextruded with and/or encapsulated by additional adhesive layers (not shown) at a higher temperature than the encapsulated extrudate. The adhesive layer may protect the barrier layer from the high temperatures necessary to adequately melt and extrude the additional adhesive layers or any other layer coextruded, laminated or otherwise disposed adjacent to the adhesive layer and/or the barrier layer.

Alternatively, the encapsulated extrudate may be coextruded with one or more layers rather than encapsulated with the adhesive layer. Specifically, the encapsulated extrudate may be coextruded with a plurality of adhesive layers on a surface of the encapsulated extrudate. Another adhesive layer may be coextruded on an opposite surface of the encapsulated extrudate. The adhesive layers may be the same material or, alternatively, may be composed of different materials. The adhesive layers may be different depending on the type of material bonded thereto to form the outside layer 136. However, any type of layer may be laminated thereon. Further, the encapsulated extrudate, including the barrier layer and the adhesive layer, may have an adhesive layer coextruded on only one surface of the encapsulated extrudate. In addition, there may be no adhesive layer disposed on the opposite surface of the encapsulated extrudate. Further, the outer layer 136 may be laminated to the adhesive layer.

FIG. 4 illustrates the improved sealant layer 400 that may be incorporated into the films 200 and 300 described above with reference to FIGS. 2 and 3. As shown in FIG. 4, the sealant layer 400 includes a plurality of layers 402 configured to act as a sealant when heated. The layers 402 are arranged on another layer in order of ascending or descending physical properties in order to enable the sealant layer 400 to act as a sealant when heated. Specifically, the arrangement of the layers 402 in order of ascending or descending physical properties enables the sealant layer 400 to be coextruded on the outer layer 136 while minimizing squeeze out and overflow of the sealant layer 400 on the outer layer 136. Thus, arranging the layers 402 in order of ascending or descending physical properties improves the reliability of the manufacturing process, decreases waste of the sealant layer 400 material, and decreases the cost to manufacture the films 200 and 300 described herein.

In the illustrated embodiment, the sealant layer 400 includes three layers. In alternative embodiments, the sealant layer may include any number of embodiments that enable the sealant layer 400 to operate as described herein. In the illustrated embodiment, the sealant layer 400 includes a first layer 404, a second layer 406, and a third layer 408. The first layer 404 is configured to be laminated to the outer layer 136 in the film 200 or is configured to be coextruded with the one or more intermediate layers 302 in film 300. The third layer 408 is an outer layer opposite the outer layer 136. The sealant layer 400 is formed by extruding the first melt stream 122 into the first layer 404, extruding the second melt stream 124 into the second layer 406, and extruding the third melt stream 126 into the third layer 408. Thus, the first layer 404 is formed of the first material 114, the second layer 406 is formed of the second material 116, and the third layer 408 is formed of the third material 118.

In the illustrated embodiment, the layers 402 are arranged in descending order of a physical property. Specifically, in the illustrated embodiment, the layers 402 are arranged in descending order of viscosity. For example, in the illustrated embodiment, the first material 114 has a first viscosity, the second material 116 has a second viscosity, and the third material 118 has a third viscosity. The first viscosity is greater than the second and third viscosities, and the second viscosity is greater than the third viscosity. Thus, the layers 402 are arranged in descending order of viscosity with the first layer 404 having the highest viscosity and the third layer 408 having the lowest viscosity. In alternative embodiments, the layers 402 may be arranged based on any physical property that enables the films 200 and 300 and the sealant layer 400 to operate as described herein. For example, in alternative embodiments, the layers 402 may be arranged based on density, thickness, and/or any other physical property.

The first layer 404 is laminated to the outer layer 136 and forms the base layer of the sealant layer 400 because it has the highest viscosity and the highest resistance to flow. Thus, the first layer 404 is capable of supporting the second and third layers 406 and 408 without overflowing the outer layer 136 because it has the highest viscosity. The second layer 406 has a lower viscosity than the first layer 404 but a higher viscosity than the third layer 408. As such, the second layer 406 resists flow more than the third layer 408 and less than the first layer 404. Thus, the second layer 406 is capable of supporting the third layer 408 without overflowing the outer layer 136 and is capable of flowing over the entire outer layer 136 to initiate a seal. The third layer 408 has the lowest viscosity and the lowest resistance to flow. Thus, when heated, the third layer 408 is capable of flowing at an increased rate to fill any void spaces caused by zippers, pleats, or triple points to form a complete seal. The increased resistance to flow of the base materials (the first layer 404 and the second layer 406) reduces overflow or squeeze out of the sealant layer 400 over the outer layer 136 while the decreased resistance to flow of the upper materials (the second layer 406 and the third layer 408) increase the flow of the sealant layer 400 when heated to fill any void spaces caused by zippers, pleats, or triple points to form a complete seal.

In the illustrated embodiment, the first layer 404 is formed of a high viscosity material and, as such, the first material 114 is a high viscosity material. The second layer 406 is formed of a medium viscosity material and the second material 116 is a medium viscosity material. The third layer 408 is formed of a low viscosity material and the third material is a low viscosity material. In the illustrated embodiment, the viscosity of the first material 114 is about 0.8 centipoise (cP), the viscosity of the second material 116 is about 0.5 cP, and the viscosity of the third material 118 is about 0.2 cP. In some embodiments, the viscosity of the first material 114 is about 0.5 cP to about 1.0 cP, the viscosity of the second material 116 is about about 0.3 cP to about 0.7 cP, and the viscosity of the third material 118 is about about 0.1 cP to about 0.4 cP alternative embodiments, the first, second, and third materials 114, 116, and 118 may have any viscosities that enable the sealant layer 400 to operate as described herein.

In the illustrated embodiment, the first material 114 may be acrylic polymers, copolymers, and terpolymers; anhydride modified polymers, copolymer, and terpolymers; vinyl acetate modified polymer; and/or any high viscosity material. Additionally, in the illustrated embodiment, the second material 116 may be acrylic polymers, copolymers, and terpolymers; anhydride modified polymers, copolymer, and terpolymers; vinyl acetate modified polymer, and/or any medium viscosity material. Finally, in the illustrated embodiment, the third material 118 may be acrylic polymers, copolymers, and terpolymers; anhydride modified polymers, copolymer, and terpolymers; vinyl acetate modified polymer; and/or any low viscosity material.

Additionally, the descending order of viscosities may also enable the sealant layer 400 to be manufactured using less material, decreasing manufacturing costs. That is, a sealant layer formed of materials of the same viscosity may have a layer thickness of that is greater than a layer thickness 410 of the sealant layer 400. For example, if the sealant layer formed of materials of the same viscosity has a 21-gauge layer thickness with each of the three layers being formed of the same low viscosity material (˜0.2 cP) and having a 7-gauge layer thickness, then the entire sealant layer will be heated to flow at an increased rate to fill any void spaces caused by zippers, pleats, or triple points. The increased flow rate causes some material to overflow outside of the outer layer 136 of the package which can coat seal bars, causing a buildup on the production equipment. The sealant layers 400 described herein reduce squeeze out and overflow by arranging the materials in a viscosity gradient as described herein. Additionally, the viscosity gradient may enable the layer thickness 410 to be less than the layer thickness of the sealant layer formed of materials of the same viscosity because the sealant layers 400 described herein reduce squeeze out and overflow, reducing the amount of material needed for the sealant layers 400 to operate effectively. For example, using the viscosity gradients described herein enables the layer thickness 410 to be from about 17-gauge to about 20-gauge and enables the sealant layers to maintain or improve overall product performance using less overall material, decreasing manufacturing costs.

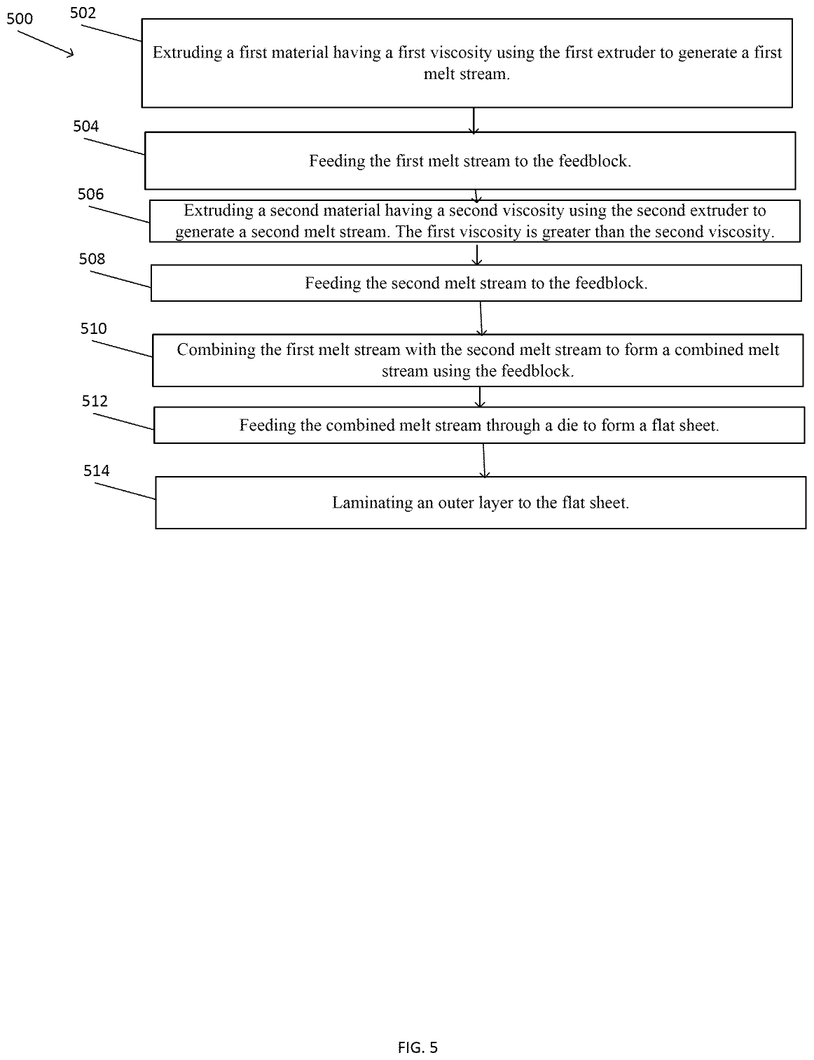

FIG. 5 is a flow diagram illustrating an example method 500 of manufacturing a film withan extrusion system. The extrusion system includes a first extruder, a second extruder, a feedblock, and a die. The method 500 includes extruding 502 a first material having a first viscosity using the first extruder to generate a first melt stream. The method 500 also includes feeding 504 the first melt stream to the feedblock. The method 500 further includes extruding 506 a second material having a second viscosity using the second extruder to generate a second melt stream. The first viscosity is greater than the second viscosity. The method 500 also includes feeding 508 the second melt stream to the feedblock. The method 500 further includes combining 510 the first melt stream with the second melt stream to form a combined melt stream using the feedblock. The method 500 also include feeding 512 the combined melt stream through a die to form a flat sheet. The method 500 further includes laminating 514 an outer layer to the flat sheet.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable withand have the same meaning as the word “comprising.” In addition, the term “based on” as used in the specification and the claims is to be construed as meaning “based at least upon.”

What is claimed is:

1. A film comprising:
an outer layer; and
a sealant layer attached to the outer layer, the sealant layer comprising:
a first layer attached to the outer layer and having a first viscosity; and
a second layer attached to the first layer and having a second viscosity, wherein the first viscosity is greater than the second viscosity.

2. The film of claim 1, wherein the sealant layer further comprises a third layer attached to the second layer.

3. The film of claim 2, wherein the third layer has a third viscosity less than the first and second viscosities.

4. The film of claim 3, wherein the first viscosity is about 0.8 centipoise (cP), the second viscosity is about 0.5 cP, and the third viscosity is about 0.2 cP.

5. The film of claim 1, wherein the first viscosity is about 0.8 cP and the second viscosity is about 0.5 cP.

6. The film of claim 1, wherein the sealant layer is laminated to the outer layer.

7. The film of claim 1, wherein the first layer is formed of a high viscosity material.

8. A film comprising:
an outer layer;
at least one intermediate layer attached to the outer layer;
a sealant layer attached to the at least one intermediate layer, the sealant layer comprising:
a first layer attached to the at least one intermediate layer and having a first viscosity; and
a second layer attached to the first layer and having a second viscosity, wherein the first viscosity is greater than the second viscosity.

9. The film of claim 8, wherein the sealant layer further comprises a third layer attached to the second layer.

10. The film of claim 9, wherein the third layer has a third viscosity less than the first and second viscosities.

11. The film of claim 10, wherein the first viscosity is about 0.8 cP, the second viscosity is about 0.5 cP, and the third viscosity is about 0.2 cP.

12. The film of claim 8, wherein the first viscosity is about 0.8 cP and the second viscosity is about 0.5 cP.

13. The film of claim 8, wherein the at least one intermediate layer is laminated to the outer layer.

14. The film of claim 8, wherein the at least one intermediate layer comprises a plurality of intermediate layers positioned between the outer layer and the sealant layer.

15. A method of manufacturing a film with an extrusion system, the extrusion system including a first extruder, a second extruder, a feedblock, and a die, the method comprising:
extruding a first material having a first viscosity using the first extruder to generate a first melt stream;
feeding the first melt stream to the feedblock;
extruding a second material having a second viscosity using the second extruder to generate a second melt stream, wherein the first viscosity is greater than the second viscosity;
feeding the second melt stream to the feedblock;
combining the first melt stream with the second melt stream to form a combined melt stream using the feedblock;
feeding the combined melt stream through a die to form a flat sheet; and
laminating an outer layer to the flat sheet.

16. The method of claim 15, wherein the extrusion system further comprises a third extruder, and wherein the method further comprises:
extruding a third material having a third viscosity using the third extruder to generate a third melt stream;
feeding the third melt stream to the feedblock; and
combining the first melt stream with the second melt stream and the third melt stream to form the combined melt stream using the feedblock.

17. The method of claim 16, wherein the third viscosity is less than the first and second viscosities.

18. The method of claim 17, wherein the first viscosity is about 0.8 cP, the second viscosity is about 0.5 cP, and the third viscosity is about 0.2 cP.

19. The method of claim 16, wherein the extrusion system further comprises a fourth extruder, and wherein the method further comprises:
extruding a fourth material using the fourth extruder to generate a fourth melt stream;
feeding the fourth melt stream to the feedblock; and
combining the first melt stream with the second melt stream, the third melt stream, and the fourth melt stream to form the combined melt stream using the feedblock.

20. The method of claim 15, wherein the first viscosity is about 0.8 cP and the second viscosity is about 0.5 cP.
